(19) United States
(12) Patent Application Publication
(10) Pub. No.: US 2024/0396109 A1
(43) Pub. Date: Nov. 28, 2024

(54) RECYCLED ELECTRODE POWDERS FROM BATTERY CURRENT COLLECTORS AND METHODS OF PROCESSING BATTERY CURRENT COLLECTORS TO RECOVER ELECTRODE POWDERS

(71) Applicant: The Regents of the University of Michigan, Ann Arbor, MI (US)

(72) Inventors: Yaohong Xiao, Ann Arbor, MI (US); Jinrong SU, Dearborn, MI (US); Lei CHEN, Ann Arbor, MI (US)

(21) Appl. No.: 18/671,138

(22) Filed: May 22, 2024

Related U.S. Application Data
(60) Provisional application No. 63/469,042, filed on May 25, 2023.

(51) Int. Cl. H01M 10/54; C01B 25/45; C01G 23/00; C01G 45/12; C01G 51/00; C01G 53/00

(52) U.S. Cl. CPC H01M 10/54; C01B 25/45; C01G 23/005; C01G 45/12; C01G 51/42; C01G 53/44; C01P 2002/70; C01P 2006/40

(57) ABSTRACT

A battery current collector recycling method, including harvesting stripped metallic bodies and the electrode powder therefrom, with the electrode powder having a higher purity than when obtained via alternative recycling methods. A method of processing a battery current collector includes the steps of heat treating the battery current collector; vibrating the battery current collector; and separating an electrode powder of the battery current collector from a metallic body of the battery current collector.

### FIELD

This invention relates generally to battery current collectors, and more particularly, to recycling lithium-ion battery current collectors to recover electrode powders.

### BACKGROUND

In order to recover valuable electrode materials (e.g., LCO and NMC) and metals (e.g., aluminum (Al) and copper (Cu)) from the battery current collectors/electrode strips of end-of-life batteries, the commonly adopted techniques can be categorized into three main groups: chemical, biological, and physical methods. Chemical methods typically utilize wet chemistry to achieve selective recovery of valuable metals, but they often involve the use of solvents, acids, or bases that generate a significant amount of waste. This can lead to secondary pollution and can incur extra costs in order to meet the standards for eco-friendliness. For instance, an N-methyl-2-pyrrolidone (NMP) solvent is commonly used to dissolve polyvinylidene fluoride (PVDF) binders and disable the connection between the electrode and current collectors, but this solvent is expensive, toxic, and environmentally harmful. Consequently, additional procedures are necessary to handle the wasted NMP solvent and also obtain pure electrode powders, including carbon black (CB) separation, filtration, washing, drying, and grinding or milling. Biological methods rely mainly on microorganisms to digest and extract metals, which can be quite time-consuming and are still in the laboratory stage.

Physical methods, such as crushing and grinding, are widely applied in both laboratory and industrial settings. However, these methods are difficult to use for complete separation and can easily introduce impurities into the resulting electrode materials. This leads to the formation of a so-called “black mass” that typically contains impurities such as carbon black, PVDF, and metal powders. Another category to achieve separation physically is sonication or ultrasonic treatment, commonly used in the laboratory to strip cathodes from Al collectors. However, the highly intensive vibration can easily cause the breaking of the Al film and introduce fine Al metal powder impurities into the cathode powders. Consequently, chemical methods are required to remove the Al metal powders, which significantly increases the separation cost.

### SUMMARY

In accordance with one embodiment, there is provided a method of processing a battery current collector, including the steps of heat treating the battery current collector; vibrating the battery current collector; and separating an electrode powder of the battery current collector from a metallic body of the battery current collector.

In various embodiments, the vibrating step occurs at a resonant frequency. The battery current collector can be placed into a container in the vibrating step, and the resonant frequency is the resonant frequency of the container. The resonant frequency may be between 50-70 Hz, inclusive. The vibrations during the vibrating step can be automatically adjusted to maintain the resonant frequency for 2-10 minutes, inclusive.

In various embodiments, vibrations during the vibrating step include both mechanical and acoustic vibrations, with vibrations during the vibrating step occurring at 40-100 g acceleration.

In various embodiments, the heat treating step includes heating the battery current collector at 450-600° C. The heat treating step may heat the battery current collector for 3 hours or more.

In various embodiments, the method includes the step of cutting the battery current collector into a plurality of pieces before the vibrating step. Each piece of the plurality of pieces can have a length of 2 cm or less.

In various embodiments, the electrode powder has less than or equal to 1 vol % metal or carbon and is 99-100 vol % lithium cobalt oxide, lithium manganese oxide, lithium nickel cobalt manganese oxide, lithium nickel cobalt aluminum oxide, lithium iron phosphate, lithium titanate, or a combination of one or more of lithium cobalt oxide, lithium manganese oxide, lithium nickel cobalt manganese oxide, lithium nickel cobalt aluminum oxide, lithium iron phosphate, and lithium titanate.

In accordance with one embodiment, there is provided a method of processing a battery current collector, comprising the steps of: placing the battery current collector in a container; vibrating the container at a resonant frequency; and separating an electrode powder of the battery current collector from a metallic body of the battery current collector.

In various embodiments, the method includes the step of pretreating the battery current collector before the placing step. The pretreating step can include cutting the battery current collector into a plurality of pieces before the placing step. The container may be filled to ⅘ or less of a volume of the container during the placing step.

In accordance with one embodiment, there is provided a recycled battery current collector, comprising a stripped metallic body made of a metal-based material and an electrode powder vibratorily obtained from the stripped metallic body. The electrode powder has less than or equal to 1 vol % carbon or the metal-based material.

In various embodiments, the electrode powder has a particle size distribution between 1 and 30 microns, inclusive. The electrode powder in at least some implementations is 99-100 vol % lithium cobalt oxide, lithium manganese oxide, lithium nickel cobalt manganese oxide, lithium nickel cobalt aluminum oxide, lithium iron phosphate, lithium titanate, or a combination of one or more of lithium cobalt oxide, lithium manganese oxide, lithium nickel cobalt manganese oxide, lithium nickel cobalt aluminum oxide, lithium iron phosphate, and lithium titanate. An X-ray diffraction analysis of the electrode powder advantageously has no carbon peaks.

It is contemplated than any of the above-listed features can be combined with any other feature or features of the above-described embodiments or the features described below and/or depicted in the drawings, except where there is an incompatibility of features.

### BRIEF DESCRIPTION OF THE DRAWINGS

Preferred example embodiments will hereinafter be described in conjunction with the appended drawings, wherein like designations denote like elements, and wherein:

FIG. 1 is flowchart illustrating example steps of a method of processing battery current collectors to recover electrode powders according to one embodiment; and

FIG. 2 shows X-ray diffraction testing results comparing a solvent-based processing method with the method of the present application.

### DESCRIPTION OF THE ILLUSTRATED EMBODIMENTS

Described herein is an efficient method of processing battery current collectors that can effectively strip electrode powders from metallic battery current collectors. The resulting electrode powders have less impurities than other recycling methods, such as solvent-based methods, and can maintain the structural integrity of the metallic body of the current collectors as compared to more rigorous stripping methods such as grinding. In accordance with some embodiments, the methods involve heat treating the battery current collectors and subjecting them to acoustic resonance vibration. As opposed to other vibratory methods, the current methods can enhance the resulting products for direct recycling.

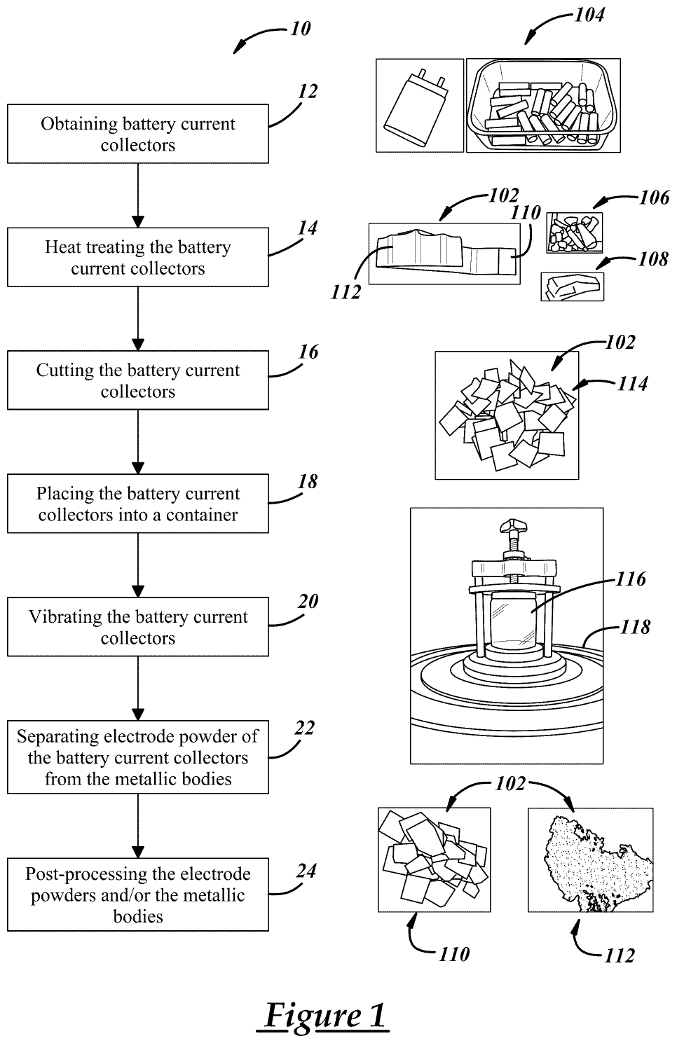

FIG. 1 is a flowchart illustrating example steps of a method 10 of processing battery current collectors to recover electrode powder. Step 12 involves obtaining battery current collectors 102 from end-of-life batteries, such as lithium (Li) ion batteries 104. While the method 10 is preferable for use with Li-ion batteries 104 recovered from vehicles, it should be understood that the method can be used with other battery types having different chemical and/or structural compositions. Recycling the battery current collectors 102 from the Li-ion batteries 104 can keep highly valuable materials from potentially being wasted.

Step 12 may involve separating the components of the Li-ion batteries 104 into their various constituent parts. For example, the end-of-life batteries 104 can be separated from their cases 106 into the battery current collectors 102 and polymer materials 108, which may be a polymer electrolyte, a polymer separator, or another component. The end-of-life battery current collectors 102 include a body 110 and electrode powder 112 that is coated on the body, which is oftentimes made of a metal-based material. The battery current collectors 102 are sometimes otherwise known as electrode strips. Before processing, the battery current collectors 102, in addition to being coated with the electrode powder 112, is also typically coated with one or more binders and carbon black. Separating the battery current collectors 102 from their cases allows for them to be processed to recover the electrode powder 112 from the metallic body 110. Accordingly, a recycled battery current collector 102 generally comprises the valuable electrode powder 112 separated from the underlying metallic body 110.

The metallic body 110 of the battery current collectors 102 is made of a metal-based material, such as steel or stainless steel, aluminum (Al), copper (Cu), or an Al-based or Cu-based alloy, to cite a few examples. Other materials for the body 110 are certainly possible. As illustrated in FIG. 1, the metallic body 110 has a thin foil structure (e.g., thickness below 20 μm, or more preferably, between 5-10 μm, inclusive). The vibratory steps described below may be particularly efficient with such a thin foil structure. However, it should be understood that the battery collectors 102 and metallic bodies 110 may take alternate forms, such as a mesh, a more 3D shaped configuration as opposed to the thin, planar foil, etc.

The electrode powder 112 is initially coated on the metallic body 110 when the battery current collectors 102 are recovered from end-of-life batteries 104. Accordingly, the battery current collectors 102 include both the underlying metallic body 110 with the coated electrode powder 112, which can be quite difficult to separate from the body. One way in which this is oftentimes done is with a solvent. However, solvent-based stripping methods are less environmentally friendly, as they usually use harsh chemicals and toxic solvents. Moreover, the resulting electrode powder 112 that is tripped from the metallic body 110 can have more impurities than the powders obtained in accordance with the present methods, as detailed further below.

The composition of the electrode powder 112 will depend on the chemistry of the end-of-life battery 104. In some embodiments, the electrode powder 112 is lithium cobalt oxide, lithium manganese oxide, lithium nickel cobalt manganese oxide, lithium nickel cobalt aluminum oxide, lithium iron phosphate, lithium titanate, or a combination of one or more of lithium cobalt oxide, lithium manganese oxide, lithium nickel cobalt manganese oxide, lithium nickel cobalt aluminum oxide, lithium iron phosphate, and lithium titanate. Other materials and combinations of materials are certainly possible.

Steps 14 and 16 of the method 10 are optional pretreating steps. Step 14 involves heat treating the battery current collectors 102, and step 16 involves cutting the battery current collectors 102. These steps can be performed in the order illustrated in FIG. 1, or it may be possible to cut the battery current collectors 102 into a plurality of pieces 114 before the heat treating step 14. It has been uncovered that heating the battery current collectors 102 at 450-600° C. for at least three hours is a desirable time and temperature profile to reduce the adhesive force between the electrode powder 112 and the metallic bodies 110. Additionally, this amount of pre-heating in step 14 can help burn off cheap binders and carbon black, thereby improving the quality, and particularly the purity, of the obtained electrode powders 112. The specific parameters for the heat treating step 14 may vary depending on the materials used for the battery current collectors 102. The temperature is typically determined by the type of binder used in the battery current collectors 102 (e.g., the binder decomposing temperature) and the type of electrode powder 112 (e.g., the temperature suggested to preserve the structure and composition of the electrode powder 112 for direct recycling).

Step 16 involves cutting the battery current collectors 102 into a plurality of battery current collector pieces 114. This may be done in an automated fashion with a cutting machine, crusher, or the like, or in this particular implementation, was done with a paper cutter given the thin dimensions of the battery current collectors 102. Step 16 can be advantageous, as cutting the battery current collectors 102 into smaller size pieces, preferably less than 2 cm in length (e.g. 1 cm×2 cm), can allow for more random movement during subsequent vibratory steps.

Step 18 involves placing the battery current collectors 102, or in some embodiments, the pieces 114, into a container 116. In the illustrated implementation, the container 116 is situated on a vibratory stage 118. As will be detailed further below, the container 116 is fixed on the vibratory stage 118 and subjected to resonant acoustic vibrations. The container 116 may be made of any operable material, such as glass, plastic, or metal, to cite a few examples. In an advantageous embodiment, an interior volume of the container 116 is filled ⅘ of the way with a plurality of battery current collector pieces 114. This allows for sufficient movement and randomization of the pieces 114 within the interior volume of the container during step 20 of the method.

Step 20 of the method 10 involves vibrating the battery current collectors 102 (which collectively may include the battery current collector pieces 114 if pretreating step 16 is performed). In a particularly advantageous embodiment, the vibrating step 20 occurs at a resonant frequency. More particularly, the vibrating step 20 occurs at a resonant acoustic frequency of the container 116, which in this embodiment, is about 50-70 Hz, inclusive. The vibratory stage 118 can be configured so as to automatically adjust the frequency to maintain at resonance. To strip the electrode powder 112 from the metallic bodies 110, step 20 may maintain resonance for 2-10 minutes, which has been shown to be sufficient for adequate separation, depending on parameters such as the size of the container 116 and the amount of battery current collectors 102. In at least some embodiments, the vibration stage 118 operates at the resonant condition of the mechanical system during step 20. The resonant frequency of the container 116 is advantageously controlled to enhance the vibration and impact of the pieces 114, which in turn improves the separation of the electrode powder 112 from the metallic bodies 110. Additionally, this helps to promote the formation of more uniform electrode powders 112, which can improve results in direct recycling. The resonant frequency used in step 20 may depend on factors such as the material properties and weight of the container 116.

In one embodiment, step 20 involves inducing vibrations of about 40-100 g acceleration, and preferably induces both acoustic and mechanical vibrations at resonance. Resonant acoustic vibrations offer the advantage of producing suitable-intensity and localized acoustic vibrations, which can efficiently break up agglomerates and dry electrode fragments, resulting in dispersed and uniform electrode powders 112. Additionally, adaptive resonant acoustic vibrations help ensure intensive bulk mechanical vibration, allowing for more random, uniform, and efficient stripping for different amounts of materials. This can help reduce the time and energy required for the stripping process, as the intensive local and bulk vibrations can accelerate the separation of electrode powders 112 from the metallic bodies 110. While mechanical vibration alone can be effective in separating materials in some embodiments, it may not be as effective in breaking up agglomerates and drying electrode fragments. Therefore, inducing both resonant acoustic and mechanical vibrations in step 20 can offer several advantages over using mechanical vibrations alone.

The vibrations in step 20 help to induce separation of the electrode powder 112 from the metallic bodies 110 in step 22. The separation in step 22 may occur in the container 116 itself. For example, the container 116 may be equipped with a mesh sieve or the like to separate the electrode powder 112 into a different area from the metallic bodies 110. Other separation methods in step 22 are certainly possible, such as magnetically separating depending on the composition of the battery current collectors 102. The electrode powder 112 recovery/separating step may be an integral part of the vibratory step 20, given that the induced vibrations mechanically separate the electrode powder 112 from the metallic bodies 110.

Step 24 is optional and may involve miscellaneous post-processing of the electrode powders 112 and/or the metallic bodies 110 from the recycled battery current collectors 102. In one embodiment, the pure electrode powders 112 are directly recycled and subjected to a re-lithiation process. In one example, a degraded cathode can be regenerated with the electrode powders 112. In another embodiment, the electrode powders 112 may be indirectly recycled, and subjected to elemental extraction or the like. Other post-processing steps are certainly possible.

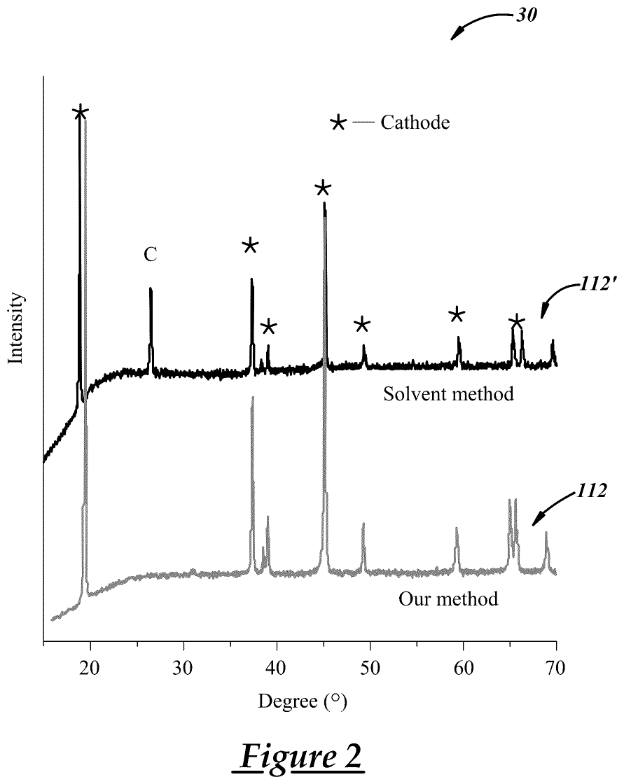

FIG. 2 shows an X-ray diffraction analysis 30, comparing electrode powder 112 obtained from the disclosed method 10, compared to a solvent-based extracted electrode powder 112′. The use of chemical solvents to remove the electrode powder 112′ can be less environmentally friendly and too complicated to get dry and pure electrode powders 112. With the present method 10, the resulting powders 112 are high in value (e.g., the most valuable cathode materials), have a uniform distribution, and high purities, free of metal powders. These characteristics make the powders suitable for direct recycling. In some advantageous implementations, the recovered electrode powder has a particle size distribution between 1 and 30 μm, inclusive. This particle size distribution can be better for direct recycling and more consistent than powders recovered via other methods.

Additionally, as shown in FIG. 2, the purity of the electrode powders 112 is improved using the method 10. In one example, the electrode powder 112 is 99-100 vol % lithium cobalt oxide, lithium manganese oxide, lithium nickel cobalt manganese oxide, lithium nickel cobalt aluminum oxide, lithium iron phosphate, lithium titanate, or a combination of one or more of lithium cobalt oxide, lithium manganese oxide, lithium nickel cobalt manganese oxide, lithium nickel cobalt aluminum oxide, lithium iron phosphate, and lithium titanate. The electrode powder 112 contains less than or equal to 1 vol % carbon or less than or equal to 1 vol % of the metal-based material used for the metallic bodies 110. This high purity level makes the electrode powders 112 better for subsequent recycling or processing. FIG. 2 shows a carbon peak C for the electrode powder 112′ obtained with solvent, whereas the electrode powder 112 obtained via the method 10 does not have the carbon peak C. The * indicates peaks for cathode material, which are all present in the electrode powders 112, 112′; however, the electrode material 112 does not have the carbon-based impurities. The level of impurities for the current method 10 is typically less than 1 vol %, and the level of impurities for the solvent-based stripping methods are greater than 1 vol % and upwards of 5 vol %. Accordingly, the method 10 produces a chemically distinct recovered powder 112 as compared to solvent-based removal and recovery methods.

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A method of processing a battery current collector, comprising the steps of:
heat treating the battery current collector;
vibrating the battery current collector; and
separating an electrode powder of the battery current collector from a metallic body of the battery current collector.

2. The method of claim 1, wherein the vibrating step occurs at a resonant frequency.

3. The method of claim 2, wherein the battery current collector is placed into a container in the vibrating step, and the resonant frequency is the resonant frequency of the container.

4. The method of claim 2, wherein the resonant frequency is between 50-70 Hz, inclusive.

5. The method of claim 2, wherein vibrations during the vibrating step are automatically adjusted to maintain the resonant frequency for 2-10 minutes, inclusive.

6. The method of claim 1, wherein vibrations during the vibrating step include both mechanical and acoustic vibrations.

7. The method of claim 6, wherein vibrations during the vibrating step occur at 40-100 g acceleration.

8. The method of claim 1, wherein the heat treating step includes heating the battery current collector at 450-600° C.

9. The method of claim 8, wherein the heat treating step heats the battery current collector for 3 hours or more.

10. The method of claim 1, comprising the step of cutting the battery current collector into a plurality of pieces before the vibrating step.

11. The method of claim 10, wherein each piece of the plurality of pieces has a length of 2 cm or less.

12. The method of claim 1, wherein the electrode powder has less than or equal to 1 vol % metal or carbon and is 99-100 vol % lithium cobalt oxide, lithium manganese oxide, lithium nickel cobalt manganese oxide, lithium nickel cobalt aluminum oxide, lithium iron phosphate, lithium titanate, or a combination of one or more of lithium cobalt oxide, lithium manganese oxide, lithium nickel cobalt manganese oxide, lithium nickel cobalt aluminum oxide, lithium iron phosphate, and lithium titanate.

13. A method of processing a battery current collector, comprising the steps of:
placing the battery current collector in a container;
vibrating the container at a resonant frequency; and
separating an electrode powder of the battery current collector from a metallic body of the battery current collector.

14. The method of claim 13, comprising the step of pretreating the battery current collector before the placing step.

15. The method of claim 14, wherein the pretreating step includes cutting the battery current collector into a plurality of pieces before the placing step.

16. The method of claim 15, wherein the container is filled to ⅘ or less of a volume of the container during the placing step.

17. A recycled battery current collector, comprising:
a stripped metallic body made of a metal-based material; and
an electrode powder vibratorily obtained from the stripped metallic body, wherein the electrode powder has less than or equal to 1 vol % carbon or the metal-based material.

18. The recycled battery current collector of claim 17, wherein the electrode powder has a particle size distribution between 1 and 30 microns, inclusive.

19. The recycled battery current collector of claim 17, wherein the electrode powder is 99-100 vol % lithium cobalt oxide, lithium manganese oxide, lithium nickel cobalt manganese oxide, lithium nickel cobalt aluminum oxide, lithium iron phosphate, lithium titanate, or a combination of one or more of lithium cobalt oxide, lithium manganese oxide, lithium nickel cobalt manganese oxide, lithium nickel cobalt aluminum oxide, lithium iron phosphate, and lithium titanate.

20. The recycled battery current collector of claim 17, wherein an X-ray diffraction analysis of the electrode powder has no carbon peaks.
